(19) United States
(12) Patent Application Publication
(10) Pub. No.: US 2008/0134348 A1
(43) Pub. Date: Jun. 5, 2008

(54) CONDITIONAL POLICIES IN SOFTWARE LICENSES

(75) Inventors: Caglar Gunyakti, Sammamish, WA (US); Wen-Pin Scott Hsu, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/566,744

(22) Filed: Dec. 5, 2006

(51) Int. Cl. G06F 21/00

(52) U.S. Cl. 726/30

(57) ABSTRACT

A software license includes conditional policies that define usage rights for software. A conditional policy contains a condition. If the condition is met, software is authorized for use in accordance with the conditional policy. Conditional policies can authorize software use in accordance with predetermined usage rights defined in the conditional policy. Conditional policies also can authorize software use as defined by plug-in computer programs provided by an independent software vendor. For example, a conditional policy can define the number of processors that can concurrently execute a software product dependent upon the type of CPU in the processor. Or, the maximum number of processors that can concurrently execute a software product can be defined in a plug-in that is called by a software license manager application, or the like.

### TECHNICAL FIELD

The technical field relates generally to computer processing, and more specifically relates to rights management via a licensing architecture that provides condition-based rights.

### BACKGROUND

Typically, before software can be executed for the first time on a processor, the software must be installed. For example, many operating systems require installation before execution. The installation process often includes some form of software production activation. During the installation process a product activation key, or the like, is provided. The product activation key, in part, activates a license that allows subsequent execution of the software in accordance with rights associated with the license.

There are problems, however, associated with current software activation solutions. Many software products comprise various versions; each version providing different functionality. For example, the product definition of many software products is not a flat structure, but rather a tree like structure with different versions of the product featuring more or less features branching out under the base product. Typical licenses, however, are flat and therefore incapable of expressing the complex licensing requirements of these modern product definitions. Thus, separate licenses are often required for each version of a product.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

A software license associated with a software product includes conditional policies that define usage rights for the software product. The usage rights defined by each conditional policy can differ. Each conditional policy has a condition associated therewith. The usage rights of a particular conditional policy are authorized for the software product if the condition associated with the conditional policy is met. Conditional policies can define predetermined usage rights, such as, for example, the maximum number of processors that can concurrently execute the software product, the maximum amount of memory allocated for a specific software application, the complete list of software applications that can run on a specific hardware configuration, and the total number of hours that a software product can run for free without requesting payment. Conditional policies also can comprise usage rights that are defined by a plug-in computer program, such as a plug-in provided by an independent software vendor.

Software licenses having conditional policies are applicable to a variety of scenarios, such as secure product activation, anti-tampering, unlocking features of software products, and kernel level enforcement of licensing policies. The use of software licenses having conditional policies allows software publishers to define flexible product SKUs (Stock Keeping Unit—an identifier that permits tracking of products and services), wherein combinations of usage rights can be enabled with a single license, rather than creating several separate SKUs for each software product or version of a software product.

### BRIEF DESCRIPTION OF THE DRAWINGS

The foregoing summary, as well as the following detailed description, is better understood when read in conjunction with the appended drawings. For the purpose of illustrating conditional policies in software licenses, there is shown in the drawings exemplary constructions thereof, however, conditional policies in software licenses are not limited to the specific methods and instrumentalities disclosed.

FIG. 1 is an example illustration of a software license comprising a plurality of conditional policies.

FIG. 2 is a flow diagram of an example process for authorizing software use via conditional policies of a software license.

FIG. 3 is a diagram of an exemplary processor for implementing a software license having conditional policies.

FIG. 4 is a depiction of an example computing environment in which a software license having conditional policies can be implemented.

### DETAILED DESCRIPTION OF ILLUSTRATIVE EMBODIMENTS

A conditional policy in a software license is indicative of usage rights for a software product associated with the software license. A conditional policy comprises a policy name and a policy value. If a condition associated with conditional policy, or policies, is met, the usage right, or rights, is defined in accordance with the policy value, or values, for that conditional policy, or policies.

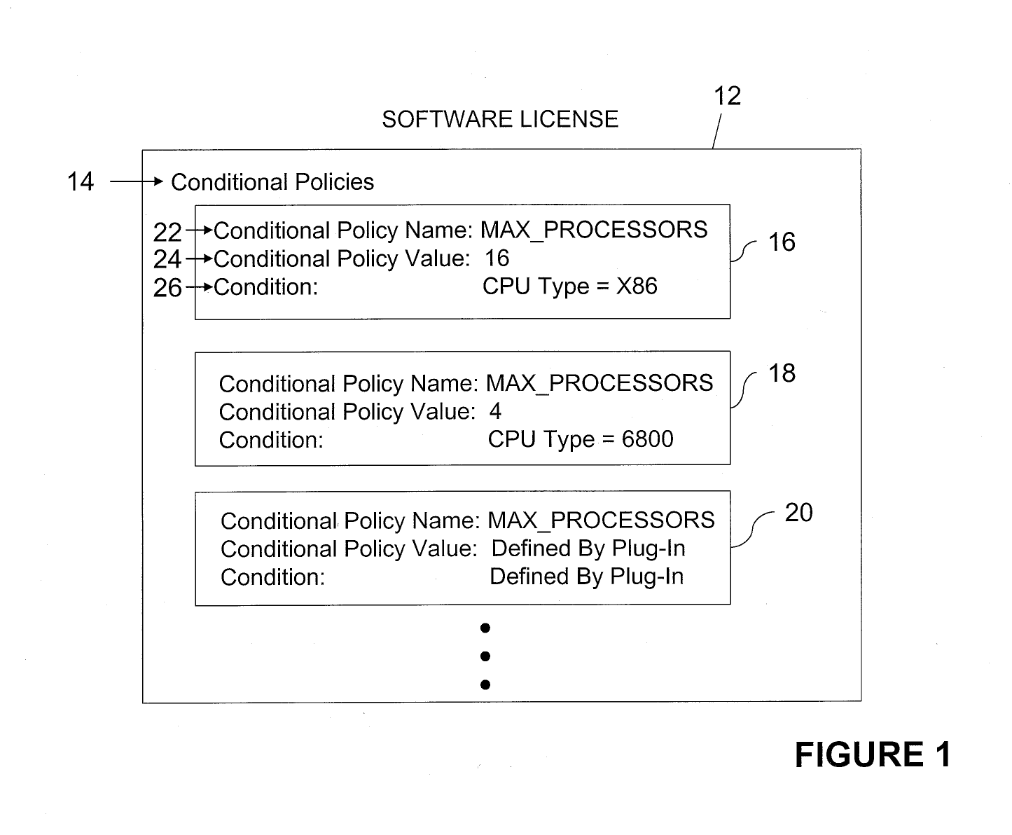

FIG. 1 is an example illustration of a software license 12 comprising a plurality 14 of conditional policies. Each conditional policy can define a different usage right for a software product associated with the software license 12. The software license 12 can be associated with any appropriate software product, such as an operating system, an application, video content, audio content, multimedia content, a game, a web service, or the like, for example. The software product, upon installation, download, and/or instantiation, will operate under various usage rights as defined by the software license 12.

In the example depiction of FIG. 1, three conditional policies 16, 18, 20 are shown. It is to be understood that the three conditional policies 16, 18, 20 are examples, and that conditional policies are not limited thereto. The conditional policy name of each conditional policy 16, 18, 20 is “MAX_PROCESSORS.” Each conditional policy 16, 18, 20 defines, for the software product associated with the software license, a usage right directed to the maximum number of processors that can execute the software product concurrently. The conditional policy 16 comprises a portion 22 indicative of the conditional policy name, a portion 24 indicative of the conditional policy value, and a portion 26 indicative of the condition associated with the conditional policy. For the conditional policy 16, the conditional policy name is MAX_PROCESSORS, the conditional policy value is 16, and the condition is CPU Type=X86 (The processor comprises one of Intel's x86 series of microprocessors.). The conditional policy 16 defines a usage right limiting the maximum number of processors that can currently execute the software product associated therewith to 16. Similarly, each of conditional policies 18 and 20 comprise a portion indicative of the conditional policy name, a portion indicative of the conditional policy value, and a portion indicative of the condition associated with the conditional policy. Note the portions for conditional policies 18 and 20 are not numbered for the sake of clarity. For conditional policy 18, the conditional policy value is 4 and the condition is CPU Type=6800 (The processor comprises a Motorola 6800 microprocessor.). For conditional policy 20, the conditional policy value is defined by a plug-in and the condition is Plug-In. Plug-ins are known in the art. A plug-in is a computer program that interacts with another computer program. In this case, the plug-in interacts with the software license 12. The software license 12 authorizes use of the software product to a maximum of 4, 16, or a plug-in defined number of concurrent processors dependent upon which conditions are met. It is to be understood that a software license is utilized in conjunction with and application (e.g. executable program) to provide authorization. For example, a program such as a Software Licensing Manager could handle licensing queries by a user application.

The example condition CPU Type=x86 could be indicative of, for example, a user who may want a license that authorizes a relatively large predetermined number (i.e., 16) of concurrent processors using the software product. The example condition CPU Type=6800 could be indicative of, for example, a user who may want a license that authorizes a relatively small predetermined number (i.e., 4) of concurrent processors using the software product. The example condition Plug-In could be indicative of, for example, a user of the software product that does not want a license limited to one of the predetermined number of concurrent processors using the software product. Rather, this use may want a license limiting the number of concurrent processors using the software product as defined by the plug-in program. The plug-in program can be provided by any appropriate source, such as an independent software vendor, a trusted source, and/or a user generated source, or the like, for example.

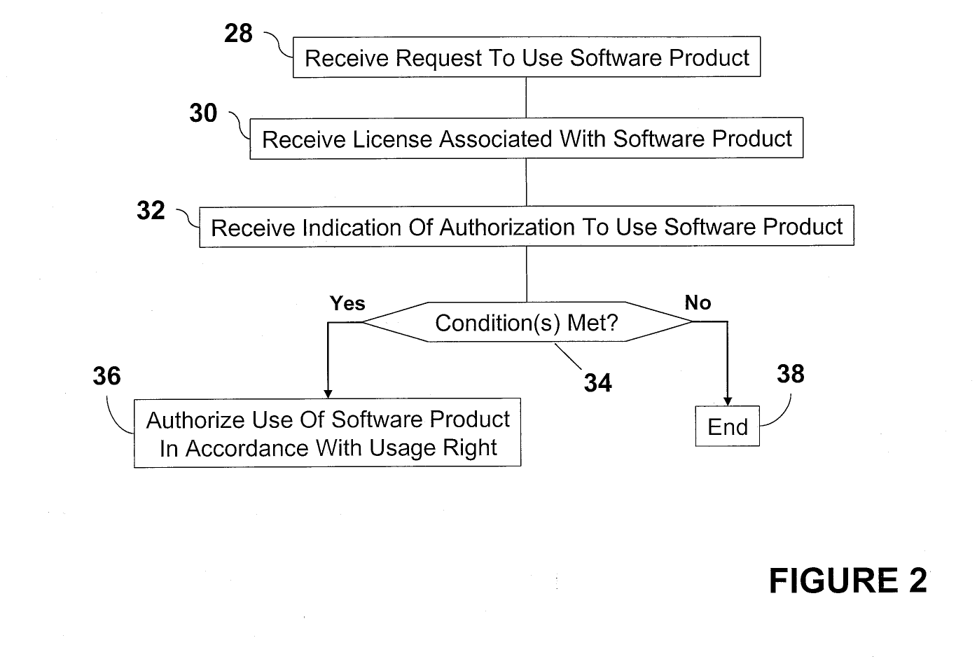

FIG. 2 is a flow diagram of an example process for authorizing software use via conditional policies of a software license. The process depicted in FIG. 2 is described with respect to FIG. 1 and an example scenario involving product validation. It is to be understood that this scenario is an example, and that applications of authorizing software use via conditional policies of a software license are not limited thereto.

At step 28, a request to use the software product is received. This request can comprise any appropriate request, such as a request to execute the software product, a request to install the software product, a request to review a portion of the software product (e.g., review a movie trailer), a request to copy the software product (or portion thereof), or the like, for example. In the example scenario, during the installation process of an operating system, the request to use the software product is in the form of a request to install the operating system. At step 30, a license(s) associated with the software product is received. In an example embodiment, the software license is received in response to a request for a license associated with the software product. In the example scenario, during the installation process, upon receiving the request to install the operating system, a request for a software license associated with the operating system is provided. The request can be provided to any appropriate source of licenses, such as a database, a network, local memory, or the like, for example. In response to the request, a software license associated with the operating system is received.

An indication of authorization to use the software product is received at step 32. Any appropriate indication of authorization to use the software product can be received, such as a cryptographic key, a validation key, a license expiration date, a URL, a phone number, or the like, for example. In the example scenario, the indication of authentication comprises a product validation key for the operating system being installed. At step 34 the indication of authorization to use the software product is compared to the conditions associated with the conditional policies of the software license. In an example embodiment, the indication of authorization to use the software product is parsed to extract a portion therein indicative of a condition. The extracted portion is compared with the portions of the conditional policies indicative of respective conditions. If a match is found (at step 34), the software product is authorized for use in accordance with the usage rights of the matching conditional policy, or policies, at step 36. If no match is found (at step 34), the process ends at step 38. An error message or the like optionally can be provided at step 38. In the example scenario, when a match is found between the product validation key and the conditional policies of the software license, the operating system is installed and authorized for use in accordance with the usage rights associated with all matching conditional policies.

Applying the process depicted in FIG. 2 to the software license depicted in FIG. 1, upon receipt of the indication of authorization to use the software product, the indication of authorization to use the software product is parsed and the portions indicative of the conditions CPU Type=x86, CPU Type=6800, and/or Plug-In are extracted. The portion indicative of condition for each conditional policy 16, 18, 20 (i.e., CPU Type=x86, CPU Type=6800, Plug-In, respectively) is compared to the extracted portion of the indication of authorization to use the software product. If the extracted portion of the indication of authorization to use the software product is indicative of the condition CPU Type=x86, the software product is authorized for concurrent use with an upper limit of 16 processors. If the extracted portion of the indication of authorization to use the software product is indicative of the condition CPU Type=6800, the software product is authorized for concurrent use with an upper limit of 4 processors. If the extracted portion of the indication of authorization to use the software product is indicative of the condition Plug-In, the software product is authorized for concurrent use with an upper limit as defined in a plug-in computer program. In this case, the plug-in is retrieved and evaluated to determine the maximum number of concurrent processors.

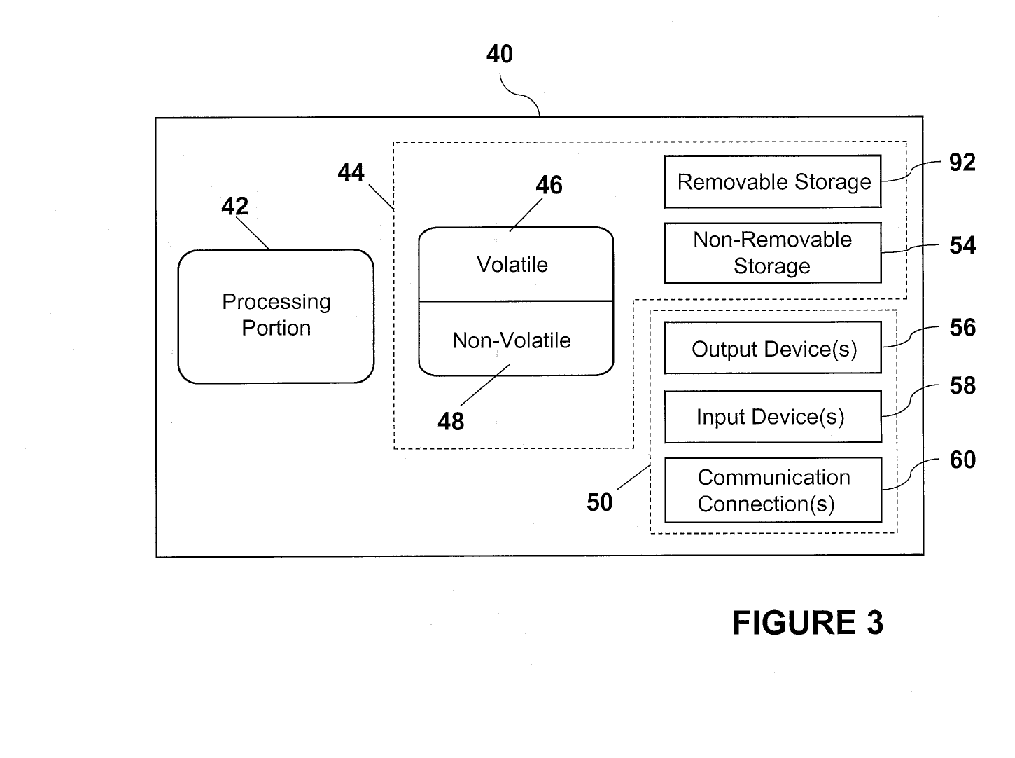

FIG. 3 is a diagram of an exemplary processor 40 for implementing software licenses having conditional policies. The processor 40 comprises a processing portion 42, a memory portion 44, and an input/output portion 50. The processing portion 42, memory portion 44, and input/output portion 50 are coupled together (coupling not shown in FIG. 3) to allow communications therebetween. The input/output portion 50 is capable of providing and/or receiving components utilized to implement software licenses having conditional policies as described above. The input/output portion 50 is capable of providing and/or receiving a request to use a software product. The input/output portion 50 is capable of providing and/or receiving a software license associated with the software product. The input/output portion 50 is capable of providing and/or receiving a request for a software license associated with the software product. The input/output portion 50 is capable of providing and/or receiving an indication of authorization to use the software product.

The processing portion 42 is capable of implementing software licenses having conditional policies as described above. The processing portion 42 also is capable of parsing an indication of authorization to use a software product. The processing portion 42 also is capable of extracting portions of an indication of authorization to use a software product. The processing portion 42 also is capable of parsing a software license having conditional policies. The processing portion 42 also is capable of extracting portions from a software license having conditional policies. The processing portion 42 also is capable of comparing an indication of authorization to use a software product with conditional policies of a software license. The processing portion 42 also is capable of authorizing usage rights of a software product in accordance with conditional policies of a software license. The processing portion 42 also is capable of verifying the authenticity of plug-ins. The memory portion 44 is capable of storing all parameters associated with implementing a software license having conditional policies.

The processor 40 can be implemented as a client processor and/or a server processor. In a basic configuration, the processor 40 can include at least one processing portion 42 and memory portion 44. Depending upon the exact configuration and type of processor, the memory portion 44 can be volatile (such as RAM) 46, non-volatile (such as ROM, flash memory, etc.) 48, or a combination thereof. The processor 40 can have additional features/functionality. For example, the processor 40 can include additional storage (removable storage 52 and/or non-removable storage 54) including, but not limited to, magnetic or optical disks, tape, flash, smart cards or a combination thereof. Computer storage media, such as memory portion 44, 46, 48, 52, and 54, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 40. Any such computer storage media can be part of the processor 40.

The processor 40 can also contain communications connection(s) 60 that allow the processor 40 to communicate with other devices. Communications connection(s) 60 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor 40 also can have input device(s) 58 such as keyboard, mouse, pen, voice input device, touch input device, etc. Output device(s) 56 such as a display, speakers, printer, etc. also can be included.

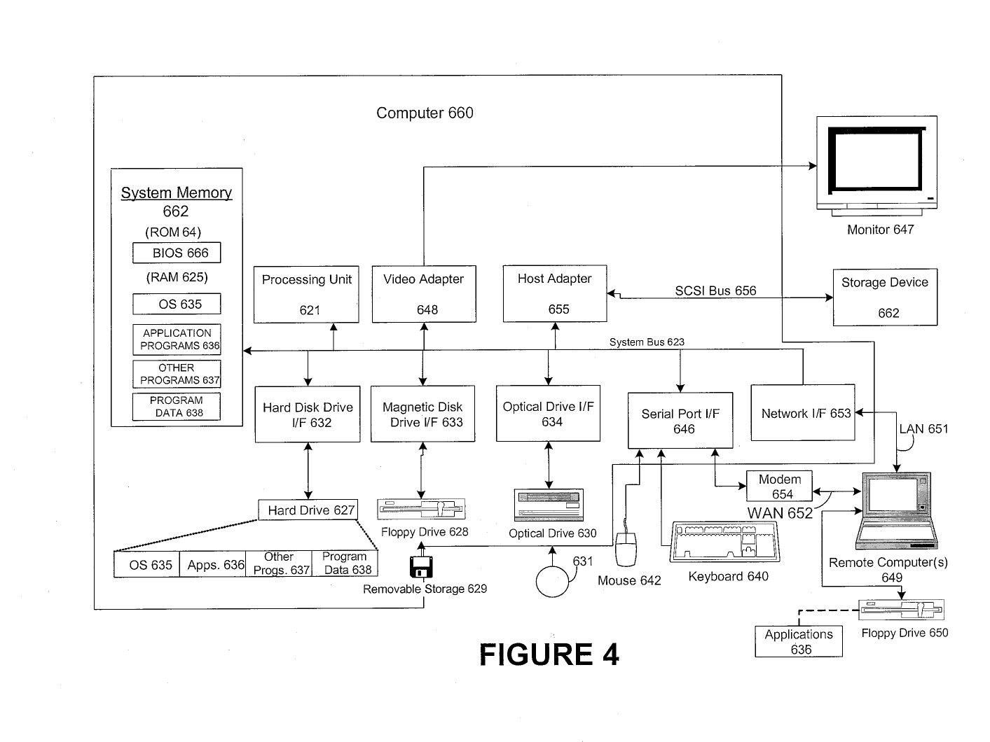

Various embodiments of a software license having conditional policies are executable on a computing device. FIG. 4 and the following discussion provide a brief general description of a suitable computing environment in which such a computing device can be implemented. Although not required, various aspects of a software license having conditional policies can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, implementation of a software license having conditional policies can be practiced with other computer system configurations, including hand held devices, multi processor systems, microprocessor based or programmable consumer electronics, network PCs, minicomputers, mainframe computers, and the like. Further, a software license having conditional policies also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 621, the memory (both ROM 664 and RAM 625), the basic input/output system (BIOS) 666, and various input/output (I/O) devices such as a keyboard 640, a mouse 642, a monitor 647, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with a software license having conditional policies as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 4, an exemplary general purpose computing system includes a conventional computing device 660 or the like, including a processing unit 621, a system memory 662, and a system bus 623 that couples various system components including the system memory to the processing unit 621. The system bus 623 may be any of several types of bus structures including a memory bus or memory controller, a peripheral bus, and a local bus using any of a variety of bus architectures. The system memory includes read only memory (ROM) 664 and random access memory (RAM) 625. A basic input/output system 666 (BIOS), containing basic routines that help to transfer information between elements within the computing device 660, such as during start up, is stored in ROM 664. The computing device 660 may further include a hard disk drive 627 for reading from and writing to a hard disk (hard disk not shown), a magnetic disk drive 628 (e.g., floppy drive) for reading from or writing to a removable magnetic disk 629 (e.g., floppy disk, removal storage), and an optical disk drive 630 for reading from or writing to a removable optical disk 631 such as a CD ROM or other optical media. The hard disk drive 627, magnetic disk drive 628, and optical disk drive 630 are connected to the system bus 623 by a hard disk drive interface 632, a magnetic disk drive interface 633, and an optical drive interface 634, respectively. The drives and their associated computer readable media provide non volatile storage of computer readable instructions, data structures, program modules and other data for the computing device 660. Although the exemplary environment described herein employs a hard disk, a removable magnetic disk 629, and a removable optical disk 631, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 629, optical disk 631, ROM 664, or RAM 625, including an operating system 635, one or more application programs 636, other program modules 637, and program data 638. A user may enter commands and information into the computing device 660 through input devices such as a keyboard 640 and pointing device 642 (e.g., mouse). Other input devices (not shown) may include a microphone, joystick, game pad, satellite disk, scanner, or the like. These and other input devices are often connected to the processing unit 621 through a serial port interface 646 that is coupled to the system bus, but may be connected by other interfaces, such as a parallel port, game port, or universal serial bus (USB). A monitor 647 or other type of display device is also connected to the system bus 623 via an interface, such as a video adapter 648. In addition to the monitor 647, computing devices typically include other peripheral output devices (not shown), such as speakers and printers. The exemplary environment of FIG. 4 also includes a host adapter 655, Small Computer System Interface (SCSI) bus 656, and an external storage device 662 connected to the SCSI bus 656.

The computing device 660 may operate in a networked environment using logical connections to one or more remote computers, such as a remote computer 649. The remote computer 649 may be another computing device (e.g., personal computer), a server, a router, a network PC, a peer device, or other common network node, and typically includes many or all of the elements described above relative to the computing device 660, although only a memory storage device 650 (floppy drive) has been illustrated in FIG. 4. The logical connections depicted in FIG. 4 include a local area network (LAN) 651 and a wide area network (WAN) 652. Such networking environments are commonplace in offices, enterprise wide computer networks, intranets and the Internet.

When used in a LAN networking environment, the computing device 660 is connected to the LAN 651 through a network interface or adapter 653. When used in a WAN networking environment, the computing device 660 can include a modem 654 or other means for establishing communications over the wide area network 652, such as the Internet. The modem 654, which may be internal or external, is connected to the system bus 623 via the serial port interface 646. In a networked environment, program modules depicted relative to the computing device 660, or portions thereof, may be stored in the remote memory storage device. It will be appreciated that the network connections shown are exemplary and other means of establishing a communications link between the computers may be used.

While it is envisioned that numerous embodiments of a software license having conditional policies are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for implementing a software license having conditional policies, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing a software license having conditional policies.

The program(s) can be implemented in assembly or machine language, if desired. In any case, the language can be a compiled or interpreted language, and combined with hardware implementations. The methods and apparatuses for implementing a software license having conditional policies also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for managing virtual machines by property. When implemented on a general-purpose processor, the program code combines with the processor to provide a unique apparatus that operates to invoke the functionality of a software license having conditional policies. Additionally, any storage techniques used in connection with a software license having conditional policies can invariably be a combination of hardware and software.

While a software license having conditional policies has been described in connection with the example embodiments of the various figures, it is to be understood that other similar embodiments can be used or modifications and additions can be made to the described embodiments for performing the same functions of a software license having conditional policies without deviating therefrom. Therefore, a software license having conditional policies as described herein should not be limited to any single embodiment, but rather should be construed in breadth and scope in accordance with the appended claims.

What is claimed:

1. A processor-implemented method for authorizing software use, the method comprising:
receiving a request to use a software product;
receiving a license associated with the software product, wherein:
the license comprises a plurality of conditional policies; and
each of the plurality of conditional policies defines at least one respective usage right of the software product;
receiving an indication of authorization to use the software product;
comparing the received indication of authorization with the plurality of conditional policies; and
authorizing at least one usage right of the software product in accordance with, respectively, at least one of the plurality of conditional policies and a result of the comparison.

2. A method in accordance with claim 1, further comprising:
if a match is found between comparing the indication of authorization with each of the plurality of conditional policies, authorizing use of the software product in accordance with the at least one respective usage right defined in the matching conditional policy.

3. A method in accordance with claim 1, wherein the indication of authorization comprises at least one of a cryptographic key, a validation key, a license expiration date, and a URL.

4. A method in accordance with claim 1, wherein at least one of the plurality of conditional policies comprises a predetermined usage right.

5. A method in accordance with claim 1, wherein at least one of the plurality of conditional policies comprises a usage right defined by a plug-in computer program.

6. A method in accordance with claim 1, further comprising installing the authorized software product.

7. A method in accordance with claim 6, wherein the software product comprises an operating system.

8. A system for authorizing software use, the system comprising:
an input/output portion configured to:
receive a request to use a software product;
receive a license associated with the software product, wherein:
the license comprises a plurality of conditional policies; and
each of the plurality of conditional policies defines at least one respective usage right of the software product;
receive an indication of authorization to use the software product; and
a processing portion configure to:
compare the received indication of authorization with the plurality of conditional policies; and
authorize at least one usage right of the software product in accordance with, respectively, at least one of the plurality of conditional policies and a result of the comparison.

9. A system in accordance with claim 8, the processing portion further configured to:
if a match is found between comparing the indication of authorization with each of the plurality of conditional policies, authorizing use of the software product in accordance with the at least one respective usage right defined in the matching conditional policy.

10. A system in accordance with claim 8, wherein the indication of authorization comprises at least one of a cryptographic key, a validation key, a license expiration date, and a URL.

11. A system in accordance with claim 8, wherein at least one of the plurality of conditional policies comprises a predetermined usage right.

12. A system in accordance with claim 8, wherein at least one of the plurality of conditional policies comprises a usage right defined by a plug-in computer program.

13. A system in accordance with claim 8, the processing portion further configured to install the authorized software product on the system.

14. A system in accordance with claim 13, wherein the software product comprises an operating system.

15. A computer-readable medium having stored thereon computer-executable instructions for authorizing software use by performing the steps of:
receiving a request to use a software product;
receiving a license associated with the software product, wherein:
the license comprises a plurality of conditional policies; and
each of the plurality of conditional policies defines at least one respective usage right of the software product;
receiving an indication of authorization to use the software product;
comparing the received indication of authorization with the plurality of conditional policies, wherein:
if a match is found between comparing the indication of authorization with each of the plurality of conditional policies, authorizing use of the software product in accordance with the at least one respective usage right defined in the matching conditional policy; and
authorizing at least one usage right of the software product in accordance with, respectively, at least one of the plurality of conditional policies and a result of the comparison.

16. A computer-readable medium in accordance with claim 15, wherein the indication of authorization comprises at least one of a cryptographic key, a validation key, a license expiration date, and a URL.

17. A computer-readable medium in accordance with claim 15, wherein at least one of the plurality of conditional policies comprises a predetermined usage right.

18. A computer-readable medium in accordance with claim 15, wherein at least one of the plurality of conditional policies comprises a usage right defined by a plug-in computer program.

19. A computer-readable medium in accordance with claim 15, the computer-executable instructions further for installing the authorized software product.

20. A computer-readable medium in accordance with claim 19, wherein the software product comprises an operating system.
